(19) United States
(12) Patent Application Publication
(10) Pub. No.: US 2002/0006096 A1
(43) Pub. Date: Jan. 17, 2002

(54) Cross erase suppression apparatus

(76) Inventor: Mitsuhiro Togashi, Yokohama (JP)

Correspondence Address: MORGAN, LEWIS & BOCKIUS, 1800 M STREET NW, WASHINGTON, DC, 20036-5869, US

(21) Appl. No.: 09/818,929

(22) Filed: Mar. 28, 2001

(30) Foreign Application Priority Data
Mar. 29, 2000 (JP) 2000-92353

(51) Int. Cl. G11B 7/135

(52) U.S. Cl. 369/53.37; 369/112.02

(57) ABSTRACT

A cross erase suppression apparatus for suppressing a cross erase phenomenon of a writable optical disc. The cross erase suppression apparatus comprises a shading element, or cross erase suppression element, arranged to shade the central portion of a beam of light to be incident on an object lens, more particularly into an aperture of the lens. The element is arranged to form a larger shading area in the direction of linear velocity of the optical disc than in a track direction of the disc such that the spot diameter becomes smaller in the track direction. The shading of the central portion of the aperture allows the spot to have a very high resolution, and be thus smaller than when a conventional flat beam of light is incident into the aperture.

### BACKGROUND OF THE INVENTION

1. Field of the Invention

The present invention relates to a cross erase suppression apparatus for suppressing a cross erase phenomenon of a writable optical disc.

2. Description of the Prior Art

A track pitch has recently become smaller in size than a light spot incident on a writable optical disc in response to requirements for a densification of the disc. For this reason, in a write mode, a pit previously recorded on a track adjacent to a writing track was reheated and thus deteriorated, which is a so-called cross erase phenomenon.

In order to suppress such a cross erase phenomenon, there have conventionally been proposed a beam shaping method using a wedge prism, and a method for setting a rim intensity (the ratio of a peripheral intensity of an object lens to a central intensity of the lens) to a desired value by adjusting the number of apertures (NA) of a collimating lens.

Further, a laser diode (LD), which is a light source, is typically wider in light distribution, higher in rim intensity and smaller in spot diameter in the vertical direction to its laminated direction than the horizontal direction to the laminated direction. For this reason, there has been proposed a method for realizing a trackwise densification by directing the vertical direction to the laminated direction of the laser diode, toward the track.

However, either the beam shaping method using the wedge prism or the method for adjusting the NA of the collimating lens has a disadvantage in that the rim intensity cannot be set to 1 or more. Further, a spot diameter in a flat light distribution is a minimum spot diameter in an associated optical system, but a light use efficiency from the LD to the spot on the disc is degraded. A writable optical pickup has a disadvantage in that it cannot actually form the flat light distribution because it must increase the light use efficiency.

Further, the method for directing the vertical direction to the laminated direction of the LD toward the track is disadvantageous in that an intensity distribution is narrow in the direction of linear velocity of the disc and an optical modulation transfer function (MTF) is degraded in the linear velocity direction. That is, in this method, a reading performance is degraded if the cross erase phenomenon is improved.

### SUMMARY OF THE INVENTION

Therefore, the present invention has been made in view of the above problems, and it is an object of the present invention to provide a cross erase suppression apparatus which is capable of reducing a spot diameter and improving a cross erase phenomenon.

In accordance with one aspect of the present invention, the above and other objects can be accomplished by the provision of a cross erase suppression apparatus comprising shading means for shading the central portion of a beam of light to be incident on an optical disc to form a spot thereon.

Preferably, the shading means may have a larger shading area in the direction of linear velocity of the optical disc than in a track direction of the disc.

Further, the shading means may be installed in an optical system between a laser light source and a ¼ λ plate.

Preferably, the cross erase suppression apparatus may further comprise control means for enabling the shading means in a write mode of the optical disc and disabling the shading means in a read mode of the optical disc.

In accordance with another aspect of the present invention, there is provided a cross erase suppression apparatus comprising phase modulation means installed at the central portion of a beam of light to be incident on an optical disc to form a spot thereon, the phase modulation means varying a refractive index of the beam of light in response to a voltage being applied thereto.

Further, the cross erase suppression apparatus may comprise control means for applying the voltage to the phase modulation means in a write mode of the optical disc and no voltage to the phase modulation means in a read mode of the optical disc.

Further, the cross erase suppression apparatus may comprise adjustment means for adjusting the level of the voltage to be applied to the phase modulation means, in such a manner that the spot has a desired diameter.

Preferably, the phase modulation means may be installed in an optical system between a laser light source and a ¼ λ plate.

Preferably, the phase modulation means may be made of liquid crystal or nonlinear optical crystal.

More preferably, the phase modulation means may be made of LiNbO.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the construction of a cross erase suppression apparatus in accordance with first and second embodiments of the present invention;

FIG. 2 is a partially enlarged, plan view of the construction of FIG. 1;

FIG. 3 is a view illustrating laser diode divergence angle-spot diameter variation characteristics in accordance with the first and second embodiments of the present invention;

FIGS. 4a to 4d are views illustrating spot characteristics based on a cross erase suppression element in accordance with the first and second embodiments of the present invention and spot characteristics based on no cross erase suppression element; and

FIG. 5 is a view illustrating the comparison between a spot reduction effect in accordance with the first and second embodiments of the present invention and a conventional spot reduction effect.

### DETAILED DESCRIPTION OF THE PREFERRED EMBODIMENTS

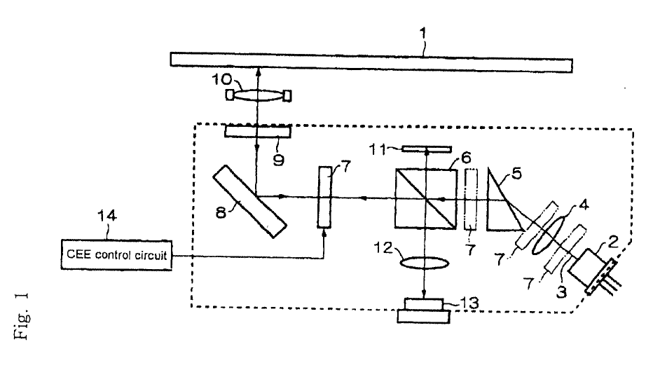

FIG. 1 is a view showing the construction of a cross erase suppression apparatus in accordance with a first embodiment of the present invention. In this drawing, or a writing operation of an optical disc 1, a laser diode (LD) 2 emits a beam of laser light 3, which is then transmitted to a mirror 8 through a collimating lens 4, wedge prism 5, prism 6 and cross erase suppression element (CEE) 7 of the present invention and reflected therefrom. Thereafter, the reflected beam of light is focused on an object lens 10 through a ¼ λ plate 9, resulting in the formation of a spot on the optical disc 1. As a result, a pit is recorded on a track of the optical disc 1.

For a reading operation of the optical disc 1, a beam of light is reflected from the disc 1 and then arrives at the prism 6 in the reverse order of the above. Thereafter, he beam of light is reflected from the prism 6 and then received by a photodiode (PD) 13 through a sensor lens 12. A CEE control circuit 14 is provided to control the CEE 7, as will be described later in detail.

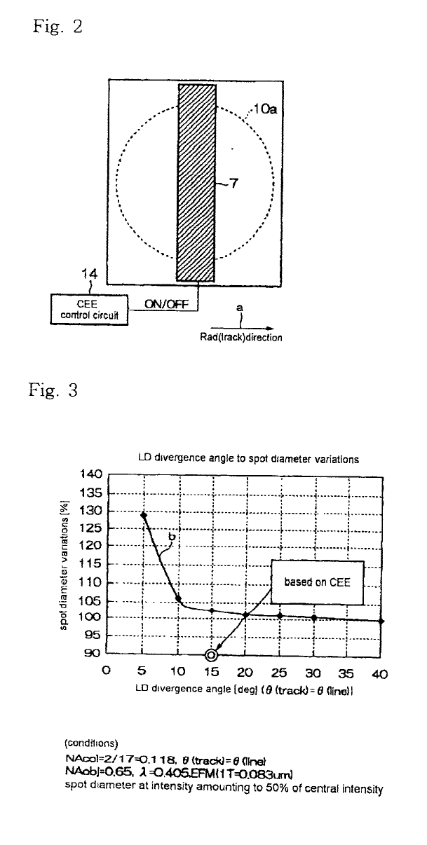

A detailed description will hereinafter be given of the CEE 7. In the present embodiment, a shading element is used as the CEE 7. FIG. 2 shows the arrangement of the shading element employed as the CEE 7, wherein the reference numeral 10a designates an aperture of the object lens 10. As shown in this drawing, the CEE 7 is arranged to shade the central portion of a beam of light to be incident on the object lens 10, more particularly into the aperture 10a of the lens 10, for the writing operation of the optical disc 1. The CEE 7 is further arranged to form, a larger shading area in the direction (Tan direction) of linear velocity of the optical disc 1 than in a track direction (Rad direction) a of the disc 1 such that the spot diameter becomes smaller in the track direction a.

The shading of the central portion of the aperture 10a, as stated above, enables the spot to have a very high resolution, and be thus smaller than when a flat beam of light is incident into the aperture.

On the other hand, the reading performance is generally degraded for a spot having a very high resolution. For example, the CEE 7 may be composed of the combination of a material capable of turning a polarization angle in response to a voltage, such as TN liquid crystal, and a polarizing filter. In the read mode, all beams of light are polarized in the same direction and then passed through the polarizing filter. But, in the write mode, the polarization angle is turned by 90° by applying a voltage to only the central portion of the aperture, thereby causing only the central portion to be shaded by the polarizing filter. That is, the central portion is shaded in the write mode, while the CEE 7 is shunted from the incident light by the CEE control circuit 14 in the read mode.

Next, a description will be made of a cross erase suppression apparatus in accordance with a second embodiment of the present invention. Notably, the second embodiment is substantially the same in construction as FIGS. 1 and 2.

In this embodiment, a phase modulation element is used as the CEE 7. The phase modulation element may be made of, for example, liquid crystal or nonlinear optical crystal, such as LiNbO.

The phase modulation element has the property of having a different refractive index from the surroundings of a voltage supply device. Because the velocity of light is in inverse proportion to the index of refraction, the application of an appropriate voltage to the phase modulation element makes it possible to set an optical phase difference of the element to a value adequate to the surroundings.

FIG. 2 shows the arrangement of the CEE 7 when it is made of LiNbO. The CEE 7 is arranged in such a manner that the spot diameter becomes smaller in the track direction a of the disc.

The same operation as that of the first embodiment is performed even when a phase difference is generated in the above way. As a result, the spot focused on the object lens 10 has a very high resolution, so that it can be smaller in size than that based on a flat beam of light. Further, the spot can be diffracted within a limited range. This spot diffraction can be attained up to about 90% of a conventional one although it varies depending on available power.

As seen from a curve b in FIG. 3, the wider the radiation angle of the LD 2 becomes, the smaller the spot diameter becomes. In this case, the spot diameter is saturated at a certain point. In FIG. 3, the dual circle shows the shifting of the phase of an area having a width which amounts to 5% of the spot diameter, by λ/2 using the CEE. This drawing shows that the spot diameter can be reduced up to 90% of that in conventional optical systems. The drawing also shows an LD divergence angle under the condition that the collimating lens has a fixed NA.

On the other hand, provided that a spot has a very high resolution, it will have a large side peak, resulting in an increase in the amount of components leaking and incoming from an adjacent track in the read node, thereby degrading the reading performance. For this reason, the CEE control circuit 14 applies a voltage to the CEE 7 only in the write mode so as to realize a significant reduction in spot diameter, and no voltage to the CEE 7 in the read mode to operate the optical system in a conventional manner so as to prevent the reading performance from being degraded.

Further, for a spot having a very high resolution in the write mode, the spot diameter can be reduced in the linear velocity direction as well as the track direction. Namely, the trackwise spot diameter and linear-velocitywise diameter can be set in an arbitrary ratio, and a small spot shape, which cannot be attained in conventional optical systems, can be obtained on the basis of the same NA and wavelength as those in the conventional optical systems.

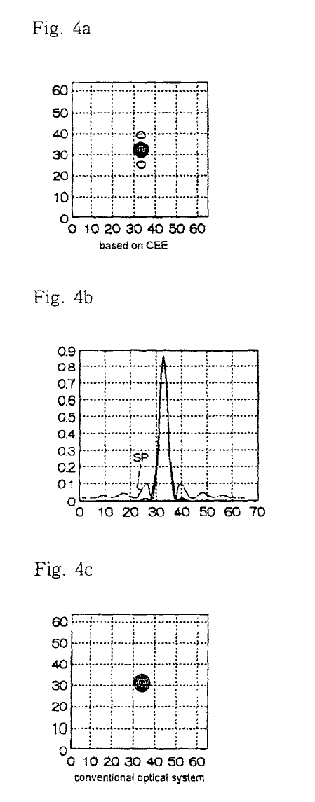

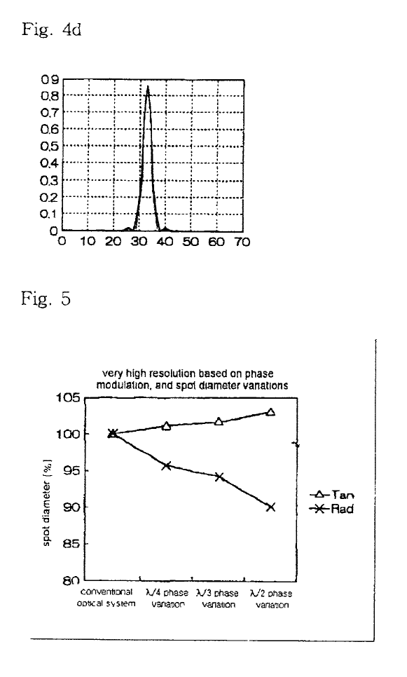

FIG. 4a shows the reduction of a spot diameter in the track direction when the CEE is used (the voltage is applied). FIG. 4b shows an optical characteristic of the spot when the CEE is used. As shown in FIG. 4b, a side peak sp is generated. FIG. 4c shows the shape of a spot in a conventional optical system where no voltage is applied. As shown in FIG. 4c, the spot is substantially circular. FIG. 4d shows an optical characteristic of the spot in the conventional optical system (where the CEE is not used). As shown in FIG. 4d, no side peak is generated.

On the other hand, as seen from the curve b in FIG. 3, the diameter of a spot on the optical disc varies with the radiation angle of the LD 2, thereby degrading the writing performance of the system.

FIG. 5 shows variations in spot diameter with phase in accordance with the second embodiment of the present invention. The spot diameter varies in response to a voltage applied to the CEE, because the phase variation is controllable by the applied voltage. As a result, the spot diameter can be set by adjusting the level of a voltage applied to the CEE 7.

In the above-described first and second embodiments of the present invention, the CEE 7 is installed between the mirror 8 and the prism 6 in FIG. 1. Alternatively, the CEE 7 may be installed at positions indicated by two-dot chain lines in FIG. 1. In other words, the CEE 7 can preferably be installed at any position between the LD 2 and the ¼ λ plate 9.

As apparent from the above description, according to the present invention, the cross erase suppression apparatus has the following effects.

Firstly, shading means or phase modulation means is provided to shade the central portion of a beam of light for the formation of a spot on an optical disc, thereby significantly reducing the diameter of the spot. Therefore, a small spot diameter, which cannot be attained in conventional optical systems, can be realized, resulting in a reduction in deterioration of an adjacent track in a write mode.

Secondly, the shading means or phase modulation means is used only in the write mode, thereby eliminating a degradation in performance in a read mode.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cross erase suppression apparatus comprising shading means for shading the central portion of a beam of light to be incident on an optical disc to form a spot thereon.

2. A cross erase suppression apparatus as set forth in claim 1, wherein said shading means has a larger shading area in the direction of linear velocity of said optical disc than in a track direction of said disc.

3. A cross erase suppression apparatus as set forth in claim 1, wherein said shading means is installed in an optical system between a laser light source and a ¼ λ plate.

4. A cross erase suppression apparatus as set forth in claim 1, further comprising control means for enabling said shading means in a write mode of said optical disc and disabling said shading means in a read mode of said optical disc.

5. A cross erase suppression apparatus comprising phase modulation means installed at the central portion of a beam of light to be incident on an optical disc to form a spot thereon, said phase modulation means varying a refractive index of said beam of light in response to a voltage being applied thereto.

6. A cross erase suppression apparatus as set forth in claim 5, further comprising control means for applying said voltage to said phase modulation means in a write mode of said optical disc and no voltage to said phase modulation means in a read mode of said optical disc.

7. A cross erase suppression apparatus as set forth in claim 5, further comprising adjustment means for adjusting the level of said voltage to be applied to said phase modulation means, in such a manner that said spot has a desired diameter.

8. A cross erase suppression apparatus as set forth in claim 5, wherein said phase modulation means is installed in an optical system between a laser light source and a ¼ λ plate.

9. A cross erase suppression apparatus as set forth in claim 5, wherein said phase modulation means is made of liquid crystal or nonlinear optical crystal.

10. A cross erase suppression apparatus as set forth in claim 5, wherein said phase modulation means is made of LiNbO.
